(19) United States
(12) Patent Application Publication
(10) Pub. No.: US 2009/0292636 A1
(43) Pub. Date: Nov. 26, 2009

(54) Method and Apparatus for Network Marketing of Financial Securities

(75) Inventor: Tetsunosuke Fujisaki, Armonk, NY (US)

Correspondence Address: RYAN, MASON & LEWIS, LLP, 1300 POST ROAD, SUITE 205, FAIRFIELD, CT, 06824, US

(73) Assignee: INTERNATIONAL BUSINESS MACHINES CORPORATION, Armonk, NY (US)

(21) Appl. No.: 12/512,546

(22) Filed: Jul. 30, 2009

Related U.S. Application Data
(62) Division of application No. 09/710,999, filed on Nov. 9, 2000.
(60) Provisional application No. 60/164,795, filed on Nov. 10, 1999.

(51) Int. Cl. G06Q 40/00

(52) U.S. Cl. 705/37

(57) ABSTRACT

A centralized financial market management system and method are disclosed that permit individual investors to trade over a network. The disclosed centralized financial market management system automatically identifies bids that are in proximity to one another and permits participants to negotiate directly in order to consummate a transaction. The disclosed centralized financial market management system permits each participant in the financial security trading market to have a unique definition of its market structure. A participant can establish various market segments, each corresponding to a group of other market participants, within the push market where bids are posted. Thus, the submitter of a bid (buy or sell) can narrowly focus the bid on select market participants. A large transaction (buy or sell) can be divided by the bid submitter into smaller units and divided over a number of market segments.

### CROSS REFERENCE TO RELATED APPLICATIONS

This application is a divisional application under 37 CFR §1.53(b)of U.S. application Ser. No. 09/710,999 filed Nov. 9, 2000 which claims the benefit of U.S. Provisional Application No. 60/164,795, filed Nov. 10, 1999.

### FIELD OF THE INVENTION

The present invention relates generally to methods and apparatus for processing financial securities transactions, and, more particularly, to methods and apparatus for buying and selling financial securities over a network.

### BACKGROUND OF THE INVENTION

Historically, transactions involving the purchase and sale of financial securities, such as bonds, stocks, commercial paper and other equities, were only permitted using closely regulated exchanges and over-the-counter trading markets, such as the New York Stock Exchange (NYSE). Most transactions involving financial securities include two categories of participants, namely, the end-investors (buyers and sellers) and brokers (brokerage firms and security houses). The end-investors include individuals and institutions, such as insurance companies, pension finds, foreign governments, mutual fund and trust companies, and commercial banks.

The secondary market for most financial securities is not as closely regulated as the primary market. Thus, after the initial purchase and sale in the primary market, many financial securities are often resold in private transactions. Generally, investors buy and sell financial securities in the secondary market in anticipation of future favorable price changes. Brokerage firms and security houses often transact in financial securities with end-investors in the secondary market in two different roles. As principals, the brokerage firms and security houses buy and sell financial securities with anticipation of future price changes. As agents, on the other hand, the brokerage firms and security houses buy and sell financial securities on behalf of their customers, typically on a commission basis.

The wide availability of electronic networks, such as the World Wide Web and electronic bulletin boards, now permits end-investors to participate in financial security transactions directly without the aid of brokerage firms and security houses. In addition to providing a valuable resource for obtaining reference material, such electronic networks provide a mechanism for centralizing financial security transactions and a clearinghouse for buyers and sellers to post and review bids for the purchase and sale of financial securities.

A number of exchanges have been developed for processing transactions involving the purchase and sale of financial securities using a public bulletin board. A number of commercial banks, including Deutsche Bank, Bear Stearns, and Credit Suisse/First Boston have developed bulletin board systems with a focus on treasury bills. In addition, a number of bulletin board systems have been developed with a focus on various bonds, such as treasury, corporate and municipal bonds, including systems by Fuji Securities, Merrill Lynch Capital Markets, Morgan Stanley Dean Witter and Spear, Leeds & Kellogg.

It has been found, however, that the complexity or uniqueness of many financial securities prevents bids for such financial securities to be posted in a standardized manner. For example, many financial securities exhibit price fluctuations that make it difficult to post bids for such financial securities. Furthermore, each financial security typically has its own set of requirements and risks, making the evaluation and comparison of two different securities nearly impossible. Thus, it is often difficult to identify financial securities of interest from among all of the available options. Generally, once posted, a bid may be accepted or rejected by other participants.

Although many points of negotiation typically remain, currently available electronic networks for the processing of financial securities transactions do not provide a mechanism for the participants to communicate.

In addition, when a bid for the purchase or sale of a financial security is posted on such an electronic network, the parameters of the bid, including the volume and total price, is typically available for the entire public to evaluate. When a bid is posted for a large transaction, however, the overall price of the financial security may be negatively impacted. A brokerage firm or security house typically divides such large transactions into smaller pieces that can be handled by a number of individual brokers who, for example, could simultaneously contact potential end-investors by telephone. Electronic networks that process financial securities transactions, however, do not provide a corresponding feature to prevent a negative price impact for a large transaction.

A need therefore exists for an electronic network for processing the purchase and sale of financial securities that permits individual investors to trade over a network without intermediate agents, brokerages, or security houses. A further need exists for a system for processing financial securities transactions that provides a network-based electronic bulletin board that permits participants to negotiate directly in order to complete transactions. Yet another need exists for a system for processing financial securities transactions that automatically identifies bids that are in proximity to one another and permits participants to negotiate in order to consummate a transaction. Another need exists for a system and method for providing a plurality of simultaneous real-time negotiation channels such that a buyer can negotiate with a plurality of sellers, and vice-versa. A further need exists for a system for processing financial securities transactions that permits a large bid (purchase or sale) for financial securities to be processed as a number of smaller transactions and that may be targeted to selected participants.

### SUMMARY OF THE INVENTION

Generally, a centralized financial market management system and method are disclosed that permit individual investors to trade over a network without intermediate agents, brokerages, or security houses. According to one aspect of the invention, the disclosed centralized financial market management system and method automatically identify bids that are in proximity to one another and permit participants to negotiate directly in order to consummate a transaction. Generally, two bids are considered to be in proximity to one another if they correspond to the purchase and sale of the same financial security, and have a price and other parameters that are within a given threshold of one another. The given threshold may be predefined or empirically determined. In one implementation, the present invention provides a plurality of simultaneous real-time negotiation channels such that a buyer can negotiate with a plurality of sellers, and vice-versa.

According to another aspect of the invention, the disclosed centralized financial market management system and method permits each participant in the financial security trading market can have a unique definition of its market structure. A participant can establish various market segments within the push market where a given participant can post a bid (buy and sell) and can monitor responses to this bid. Each market segments corresponds to a group of other market participants to which the respective market participant is willing to announce its bids.

The personalized market segments of the present invention allow the submitter of a bid (buy or sell) for a financial security to narrowly focus the bid on select market participants. Thus, buyers and sellers can post their bids only to targeted groups of other market participants to minimize and otherwise control the range of exposure of the trading intention to others in the market. In addition, the personalized market segments can be dynamically adjusted by the respective market participant, as desired.

Furthermore, the market structure of the present invention allows a large transaction (buy or sell) to be divided by the bid submitter into smaller units and divided over a number of market segments. Thus, participants in one market segment will not be aware of bids associated with the same transaction in other market segments. In this manner, a submitter of a bid (buy or sell) associated with a large transaction can control the transaction in a manner that will not adversely impact the price.

A more complete understanding of the present invention, as well as further features and advantages of the present invention, will be obtained by reference to the following detailed description and drawings.

### BRIEF DESCRIPTION OF THE DRAWINGS

FIG. 1 illustrates an exemplary network environment in which the present invention can operate;

FIG. 2 illustrates the market structure for two exemplary participants in accordance with the present invention;

FIG. 3 is a block diagram showing the architecture of an illustrative centralized financial market management system of FIG. 1;

FIG. 4 is a block diagram showing the architecture of an illustrative market participant (terminal) of FIG. 1;

FIG. 5 illustrates an exemplary table from the market segment database of FIG. 3;

FIG. 6 illustrates an exemplary table from the market (bid) database of FIG. 3;

FIG. 7 is a flow chart describing the market segment definition process of FIG. 4 in accordance with the present invention;

FIG. 8 is a flow chart illustrating the market segment management process of FIG. 3 incorporating features of the present invention;

FIGS. 9A and 9B, collectively, are a flow chart illustrating the server bid processing routing of FIG. 3 incorporating features of the present invention;

FIGS. 10A and 10B, collectively, are a flow chart illustrating the client bid processing routing of FIG. 4 incorporating features of the present invention;

FIG. 11 illustrates an exemplary bid submission interface that assists the user with the submission of a bid;

FIG. 12 illustrates an exemplary push market interface that provides a user with information about bids in the push market of FIG. 2; and

FIG. 13 illustrates an exemplary pull market interface that provides a user with information about bids in the pull market of FIG. 2.

### DETAILED DESCRIPTION OF PREFERRED EMBODIMENTS

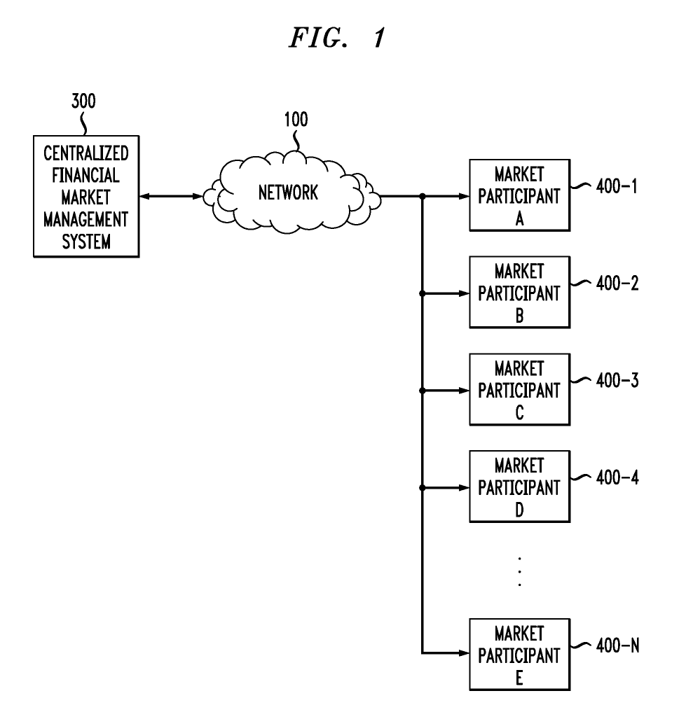

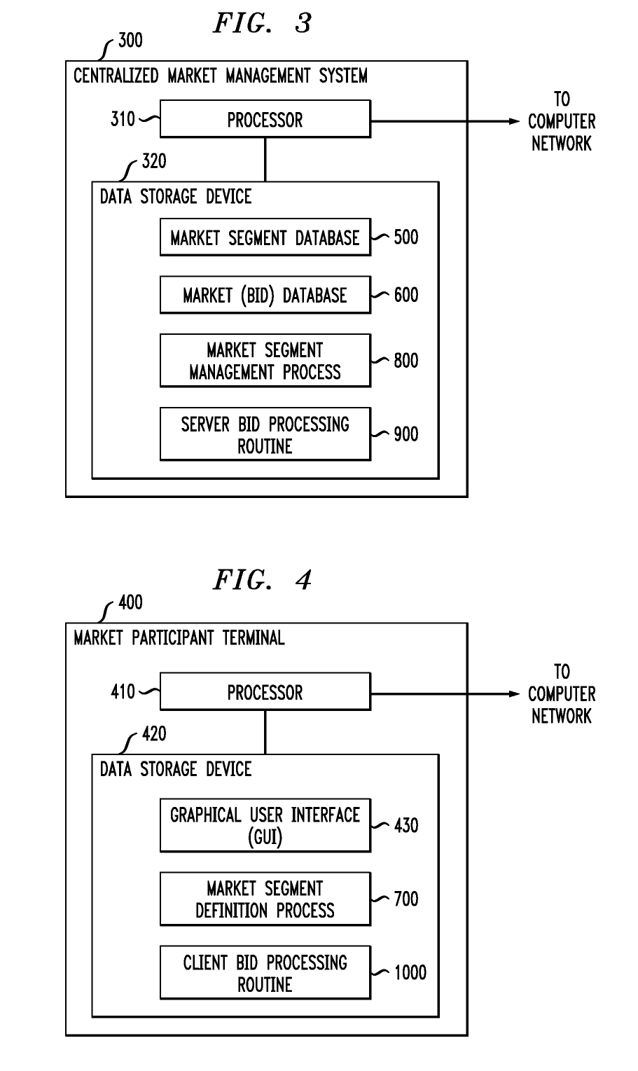

FIG. 1 illustrates an exemplary network environment 100 in which the present invention can operate. As shown in FIG. 1, a centralized financial market management system 300, discussed further below in conjunction with FIG. 3, coordinates transactions involving the purchase and sale of financial securities, including bonds, stocks, commercial paper and other equities, for a number of market participants 400-1 through 400-N, hereinafter, collectively referred to as market participants 400, discussed further below in conjunction with FIG. 4. It is noted that market participants 400 may be individuals or various business organizations, such as corporations, partnerships or sole proprietorships. The network environment 100 may be comprised of any combination of public or proprietary networks, including the Internet, the World Wide Web, the Public Switched Telephone Network (PSTN), a cable network, a credit card network, a point-of-sale processing network, or a wireless network, including a cellular telephone network, the wireless Web or a digital satellite service (DSS) network.

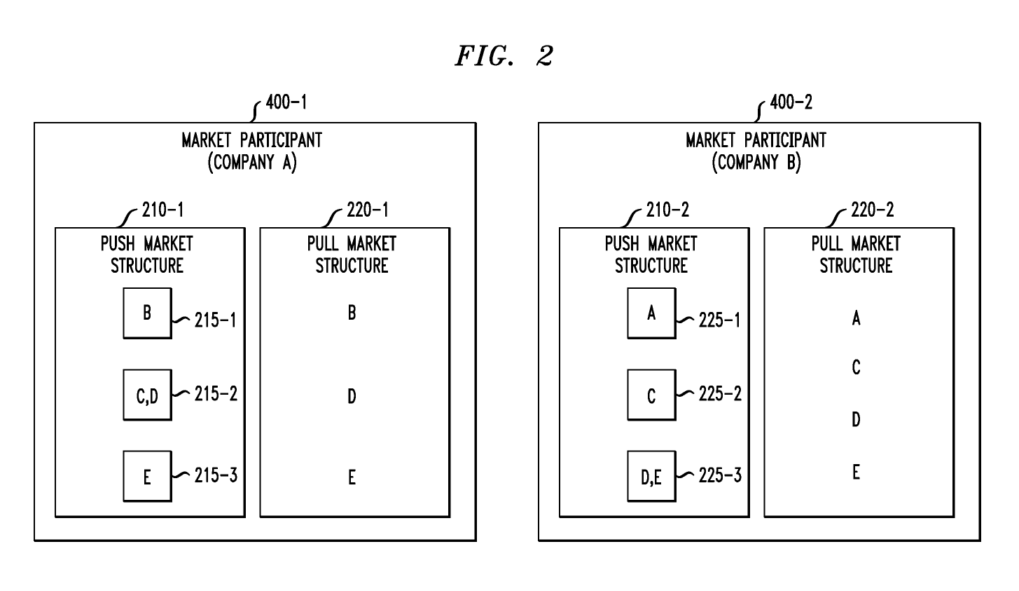

The present invention provides a network-based negotiable market for financial security trading. According to one aspect of the present invention, shown in FIG. 2, each participant 400 in the financial security trading market can have a unique definition of its market structure. FIG. 2 illustrates the market structure for two exemplary participants 400-1 (participant A) and 400-2 (participant B), where A, B, C, D, and E are the participants 400 in the illustrative trading market. The market structure of each company 400-N comprises two regions, namely, a push market 210-N and a pull market 220-N.

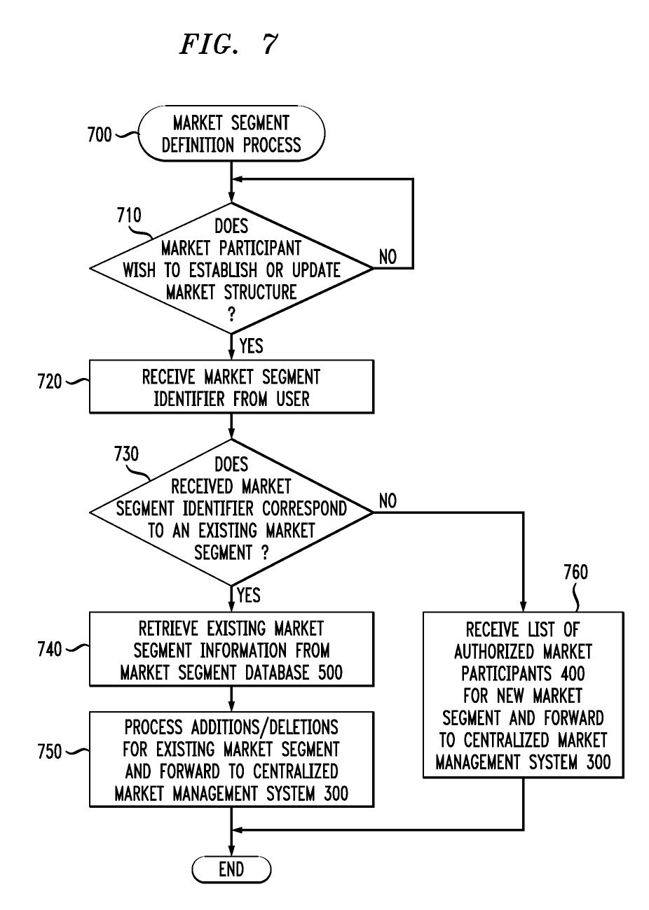

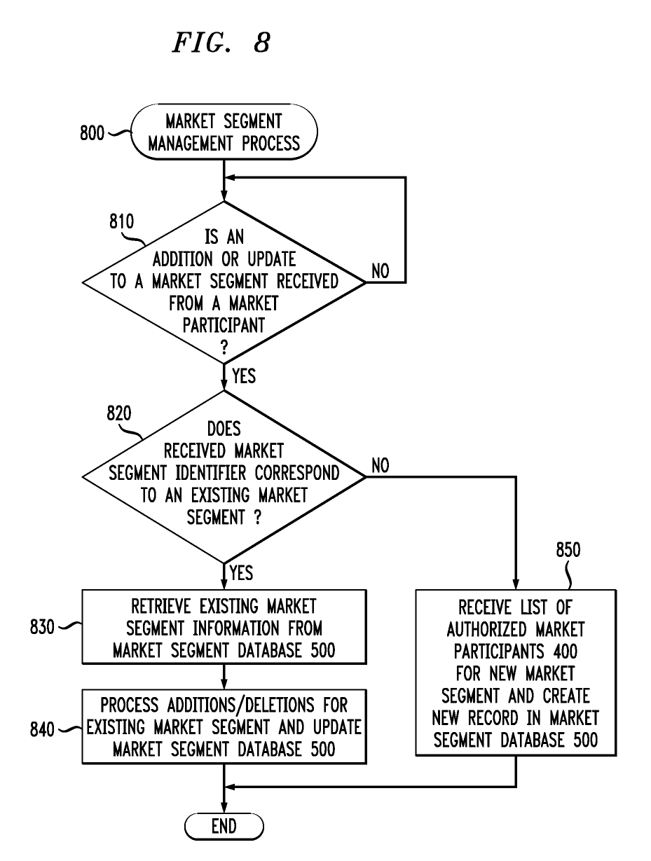

A push market 210 is the region where the market participants 400 posts their corresponding bids (buy and sell) and can monitor responses to these bids. As shown in FIG. 2, a push market 210 further comprises one or more market segments 215-N, each corresponding to a group of other market participants 400 to which the respective market participant 400 is willing to announce its bids. In FIG. 2, market participant 400-1 has defined three market segments 215 inside the push market 210 corresponding to three groupings of market participants 400. A first grouping 215-1 of participants includes only participant B, a second grouping 215-2 of participants includes participants C and D; and a third grouping 215-3 of participants includes only company E. Market participant 400-2 (Company B), on the other hand, defines a different market structure for its push market 210. Market participant 400-2 defines three market segments 225-1 through 225-3, corresponding to three groupings of participants, as follows A; C and D; and E, respectively. The manner in which the market participants 400 establish and update a desired market structure is discussed further below in conjunction with FIGS. 4 and 7.

In this manner, the personalized market segments 215-N of the present invention allow the submitter of a bid (buy or sell) for a financial security to narrowly focus the bid on select market participants 400. Thus, buyers and sellers can post their bids only to targeted groups of other market participants 400 to minimize and otherwise control the range of exposure of the trading intention to others in the market. In addition, the personalized market segments 215-N can be dynamically adjusted by the respective market participant 400 as desired, in a manner discussed below in conjunction with FIG. 7.

Furthermore, the market structure of the present invention allows a large transaction (buy or sell) to be divided by the bid submitter into smaller units and divided over a number of market segments 215-N. Thus, participants 400 in one market segment 215-N will not be aware of bids associated with the same transaction in other market segments 215-N. In this manner, a submitter of a bid (buy or sell) associated with a large transaction can control the transaction in a manner that will not adversely impact the price.

As shown in FIG. 2, a pull market 220-N is comprised of a single region where the market participants 400 can monitor posted bids from other market participants 400. However, the contents in the pull market 220-N may vary depending on the corresponding market participants 400. Generally, and as discussed further below, the pull market 220 of a given participant 400 is determined based on the market segments defined by all other market participants 400 that include the given market participant 400. In other words, the push market structure defined by other market participants 400 determines the pull market of a given market participant 400. Thus, the “pull” market of a participant is determined as the result of invitations from other market participants 400 given as the push market structure definitions. If company A is listed in the push market structure for three other market participants 400, then company A's pull market will contain bids from these three companies. As shown in FIG. 2, bids from companies A, C, D, and E are visible for market participant 400-2 (Company B). Market participant 400-1 (Company A), on the other hand, can monitor bids only from three market participants 400, namely, participants B, D and E. Thus, the present invention allows bids that are visible to each company to vary, in contrast to the public bulletin board system where all participants share the same collection of bids.

According to another feature of the present invention, a new bid is compared to other bids that have been submitted to the centralized financial market management system 300 to identify bids that are in “proximity.” Generally, two bids are considered to be in proximity if they represent a buy and a sell, and have a price and other parameters that are within a given threshold of one another. The given threshold may be predefined or empirically determined. In one implementation, a real-time communication channel is automatically established between the buyer and seller of bids that are in proximity. Alternatively, an introduction may be provided between the two parties using electronic mail messages. Thus, one or more negotiation channels are provided between the parties over the network environment 100 to permit buyers to negotiate with a number of sellers simultaneously, and likewise, to permit sellers to negotiate with a number of buyers simultaneously. In this manner, buyers and sellers can compare their respective asking and offering prices in an efficient manner. Collaboration can be performed using any well-known methods of the prior art, such as those described in U.S. patent application Ser. No. 08/722,287, filed on Sep. 27, 1996 to Fin et al., entitled “Internet Web Page Sharing”, incorporated by reference herein.

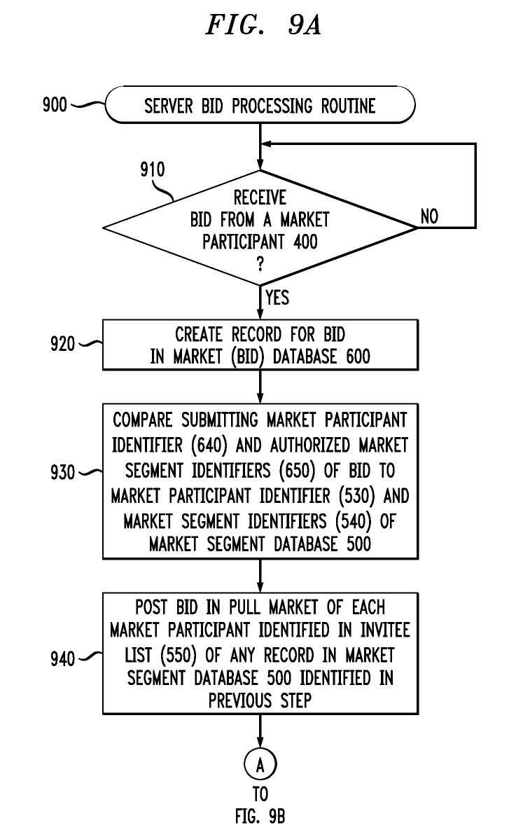

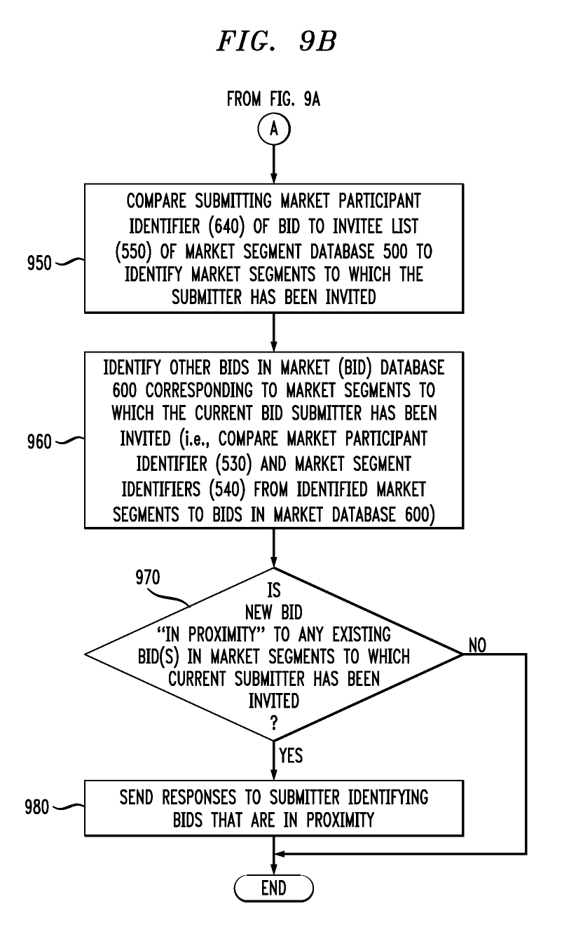

FIG. 3 is a block diagram showing the architecture of an illustrative centralized financial market management system 300. The centralized financial market management system 300 preferably includes certain standard hardware components, such as a processor 310 and a data storage device 320. The processor 310 can be linked to other elements, either by means of a shared data bus, or dedicated connections, as shown in FIG. 3. The processor 310 may be embodied as a single commercially available processor, or as a number of such processors operating in parallel. The data storage device 320 and/or ROM (not shown) are operable to store one or more instructions, discussed further below in conjunction with FIGS. 8 and 9, which the processor 310 is operable to retrieve, interpret and execute. A communications port (not shown) connects the centralized financial market management system 300 to market participants 400, for example, by means of an Internet connection using the public switched telephone network (PSTN). The communications port can include multiple communication channels for simultaneously establishing a plurality of connections.

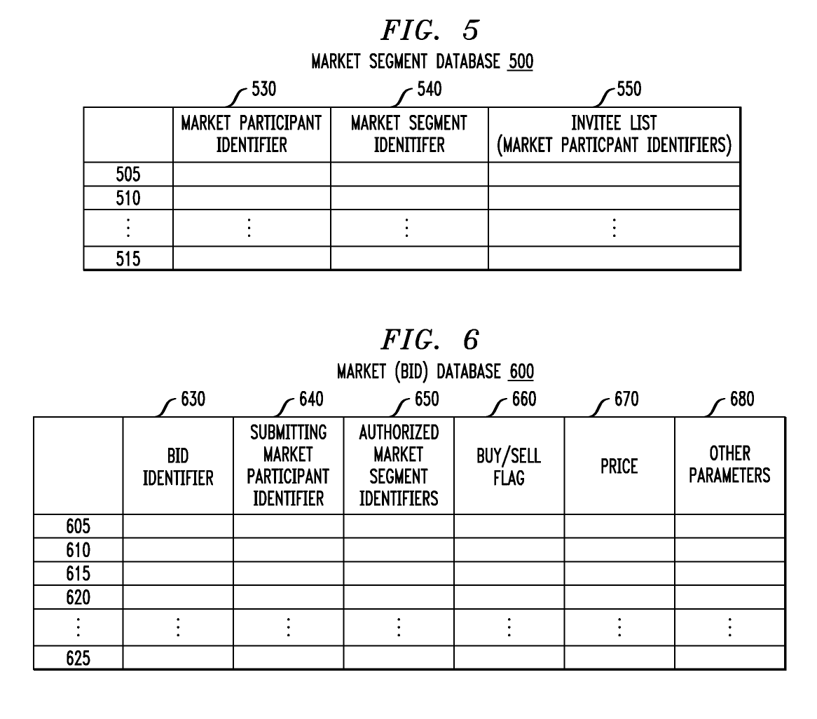

As discussed further below in conjunction with FIGS. 5 and 6, respectively, the data storage device 320 includes a market segment database 500 and a market (bid) database 600. Generally, the market segment database 500 stores information defining the various market segments 215-N for each of the market participants 400. In addition, the market (bid) database 600 contains a record of each bid (buy or sell) being processed by the centralized financial market management system 300, including the price and other terms of the bid.

In addition, the data storage device 320 includes a market segment management process 800 and a server bid processing routine 900, each discussed further below in conjunction with FIGS. 8 and 9, respectively. Generally, the market segment management process 800 receives new market segment definitions from the market participants 400 and updates the market segment database 500. The server bid processing routine 900 receives each bid from a market participant 400, posts each bid in the appropriate pull markets 220 of other market participants 400 and compares the received bid to other previously received bids to identify bids that are in proximity of one another.

FIG. 4 is a block diagram showing the architecture of an illustrative market participant terminal 400. Each market participant 400 preferably includes certain standard hardware components, such as a processor 410 and a data storage device 420. Each of these components may be identical to those described above in conjunction with FIG. 3. In addition, the market participant terminal 400 includes a well-known graphical user interface (GUI) 430 that allows the market participant (user) 400 to interact with the processes executing on the terminal 400, in a known manner. A communications port (not shown) connects the market participant terminal 400 to other market participants 400 and the centralized financial market management system 300, for example, by means of an Internet connection using the public switched telephone network (PSTN).

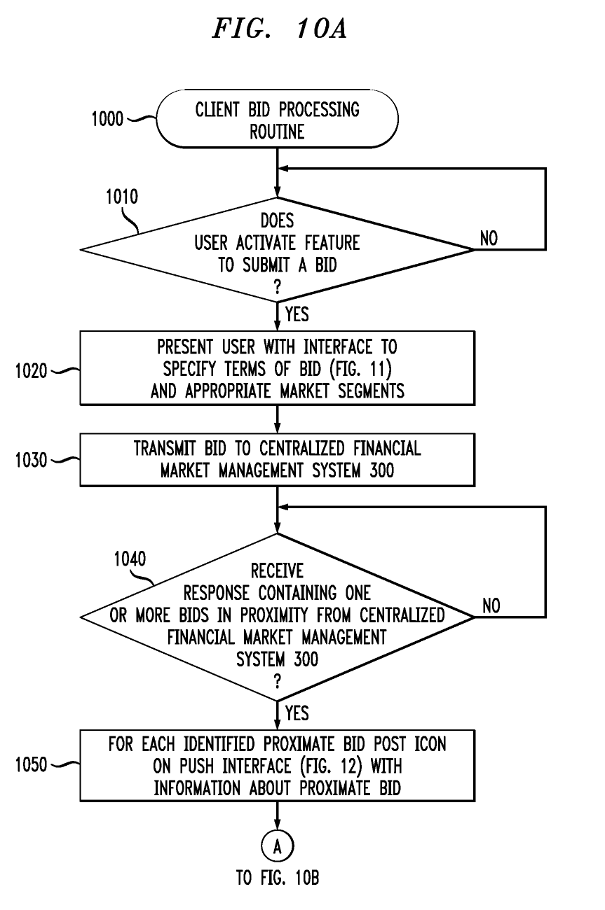

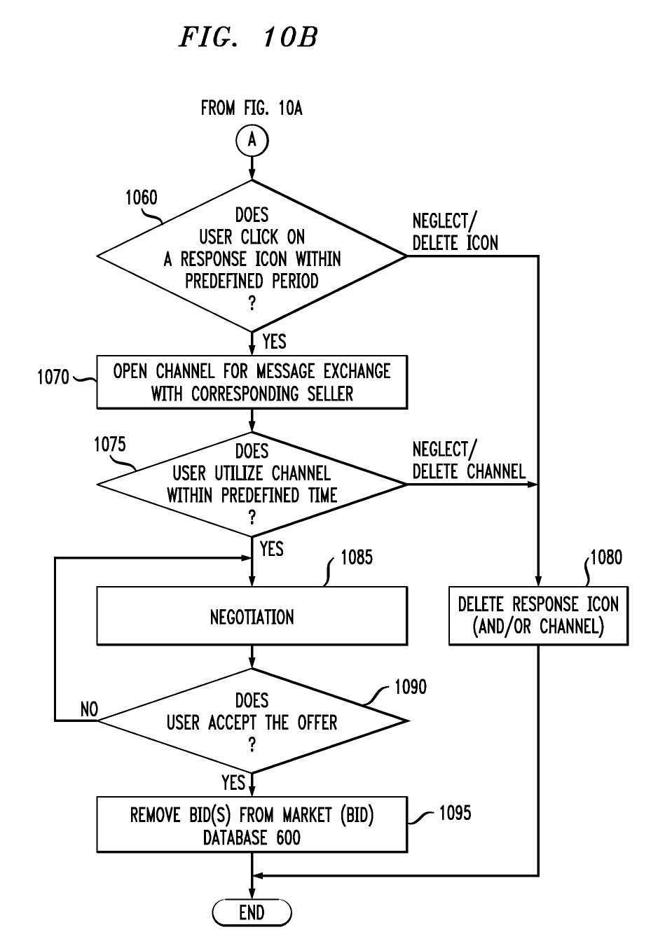

As discussed further below in conjunction with FIGS. 7 and 10, respectively, the data storage device 420 includes a market segment definition process 700 and a client bid processing routine 1000. Generally, the market segment definition process 700 allows a respective market participant 400-N to establish and/or update its own push market structure 210-1. The client bid processing routine 1000 assists a market participant 400 in generating and submitting a bid (buy or sell) and associating the bid with one or more desired market segments 215, 225. In addition, the client bid processing routine 1000 permits the market participant 400 to process responses from the centralized financial market management system 300 associated with bids from other market participants 400 that are in proximity of one another.

FIG. 5 illustrates an exemplary market segment database 500 that can store information defining the various market segments 215-N for each of the market participants 400. The market segment database 500 maintains a plurality of records, such as records 505-515, each associated with a different market segment of a given market participant 400. For each unique combination of market participant 400 and market segment identified in fields 530 and 540, respectively, the market segment database 500 indicates the other market participants 400 that are included in the market segment. The manner in which the market segment database 500 is managed by the centralized financial market management system 300 is discussed below in conjunction with FIG. 8.

FIG. 6 illustrates an exemplary market (bid) database 600 that contains a record of each bid (buy or sell) being processed by the centralized financial market management system 300, including the price and other terms associated with the bid. The market (bid) database 600 maintains a plurality of records, such as records 605-625, each associated with a different bid. For each bid identified in field 630, the market (bid) database 600 identifies the corresponding submitting market participant 400 in field 640, authorized market segments 215, 225 in which the bid may appear in field 650, a flag in field 660 indicating whether the bid is a buy or sell, and the corresponding price and other applicable parameters in fields 670 and 680, respectively. The other applicable parameters specified in fields 680 can optionally include yield, maturity date for bonds, coupon rates, options; settlement date and maturity date, interest rate for commercial papers. It is noted that the authorized market segments 215, 225 in which the bid may appear, as set forth in field 650, may be specified using a wildcard, such as the “*” character, which indicates that the bid can be matched to any company and will be visible to the public.

As previously indicated, each market participant 400 executes a market segment definition process 700, shown in FIG. 7, to establish and/or update its own push market structure 210-1. As shown in FIG. 7, the market segment definition process 700 is initiated during step 710 when a market participant 400 indicates a desire to establish or update a market structure 215. Thereafter, during step 720, the market segment definition process 700 receives the market segment identifier from the user.

A test is performed during step 730 to determine if the received market segment identifier corresponds to an existing market segment. If it is determined during step 730 that the received market segment identifier corresponds to an existing market segment, then the corresponding market segment information is retrieved from the market segment database 500 during step 740 and the additions and/or deletions for the existing market segment are processed during step 750 and forwarded to the centralized financial market management system 300.

If, however, it is determined during step 730 that the received market segment identifier does not corresponds to an existing market segment, then the list of authorized market participants 400 for the new market segment is received during step 760 and forwarded to the centralized financial market management system 300, before program control terminates.

As previously indicated, the centralized financial market management system 300 executes the market segment management process 800, shown in FIG. 8, to receive new market segment definitions from the market participants 400 and update the market segment database 500. As shown in FIG. 8, the market segment management process 800 is initiated during step 810 when a an addition or update to a market segment is received from a market participant 400.

Thereafter, a test is performed during step 820 to determine if the received market segment identifier corresponds to an existing market segment. If it is determined during step 820 that the received market segment identifier corresponds to an existing market segment, then the corresponding market segment information is retrieved from the market segment database 500 during step 830 and the additions and/or deletions for the existing market segment are processed during step 840 to update the market segment database 500.

If, however, it is determined during step 820 that the received market segment identifier does not corresponds to an existing market segment, then the list of authorized market participants 400 for the new market segment is received during step 850 and a record is created in the market segment database 500, before program control terminates.

As previously indicated, the centralized financial market management system 300 executes the server bid processing routine 900, shown in FIGS. 9A and 9B, to receive each bid from a market participant 400, post each bid in the appropriate pull markets 220 of other market participants 400 and compare the received bid to other previously received bids to identify bids that are in proximity of one another. As shown in FIG. 9A, the server bid processing routine 900 is initiated during step 910 upon the receipt of a bid from a market participant 400.

Thereafter, a record is created for the bid in the market (bid) database 600 during step 920. The submitting market participant identifier (640) and the authorized market segment identifiers (650) of the bid are then compared during step 930 to the market participant identifier (530) and the market segment identifiers (540) of the market segment database 500. The bid is then posted during step 940 in the pull market 220 of each market participant 400 identified in the invitee list (550) of any record in the market segment database 500 identified during step 930.

As shown in FIG.>9b, the server bid processing routine 900 then compares the submitting market participant identifier (640) of the bid to the invitee list (550) of the market segment database 500 during step 950 to identify the market segments to which the submitter has been invited. Other bids in the market (bid) database 600 corresponding to market segments to which the current bid submitter has been invited are identified during step 960 (i.e., compare market participant identifier (530) and market segment identifiers (540) from identified market segments to bids in market database 600).

A test is performed during step 970 to determine if the new bid is “in proximity” to any existing bid(s) in market segments to which the current submitter has been invited. Generally, two bids are “in proximity” if they correspond to a buy and a sell, respectively, and have a price and other parameters that are within a given threshold of one another. The thresholds may be predefined or empirically determined.

If it is determined during step 970 that the new bid is “in proximity” to any existing bid(s) in market segments to which the current submitter has been invited, then responses are sent during step 980 to the submitter identifying the bids that are in proximity. In addition, as previously indicated, simultaneous communication channels can also be established between the parties to facilitate negotiation.

If, however, it is determined during step 970 that the new bid is not “in proximity” to any existing bid(s) in market segments to which the current submitter has been invited, then program control terminates.

As previously indicated, the market participants 400 can execute a client bid processing routine 1000 to assist a given market participant (user) 400 in generating and submitting a bid (buy or sell) and associating the bid with one or more desired market segments 215, 225. In addition, the client bid processing routine 1000, shown in FIGS. 10A and 10B, permits the market participant 400 to process responses from the centralized financial market management system 300 associated with bids from other market participants 400 that are in proximity of one another.

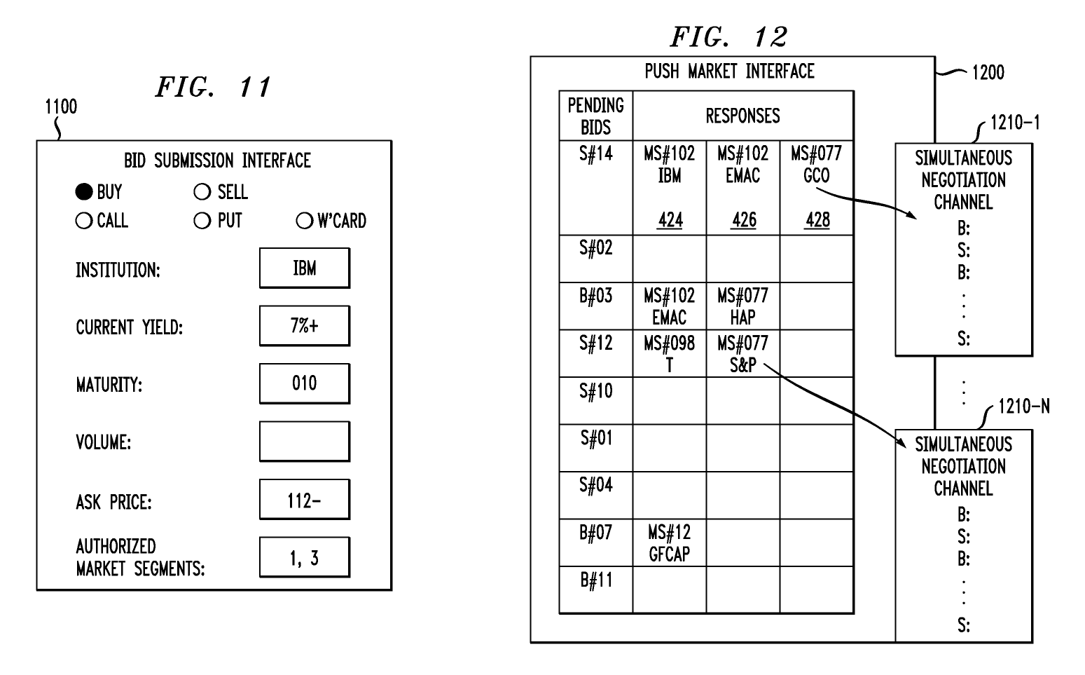

As shown in FIG. 10A, the client bid processing routine 1000 is initiated during step 1010 when a user activates a feature to submit a bid. Thereafter, the user is presented during step 1020 with an interface, such as the interface discussed below in conjunction with FIG. 11, to specify the terms of the bid and any appropriate market segments. It is again noted that a bid can be assigned to a number of market segments in parallel. In addition, assigning a bid to a market segment will publicize the bid to the market participants 400 within the market segment, while market participants 400 that are not within the specified market segment(s) will not be aware of the bid. Thus, disclosure of bids can be fully controlled in terms of the information releasing.

The bid is then transmitted during step 1030 to the centralized financial market management system 300. A test is performed during step 1040 to determine if a response is received identifying one or more bids that are in proximity from the centralized financial market management system 300. If it is determined during step 1040 that a response is not received identifying one or more bids that are in proximity, then program control returns to continue executing step 1040 until a response is received or a time-out occurs.

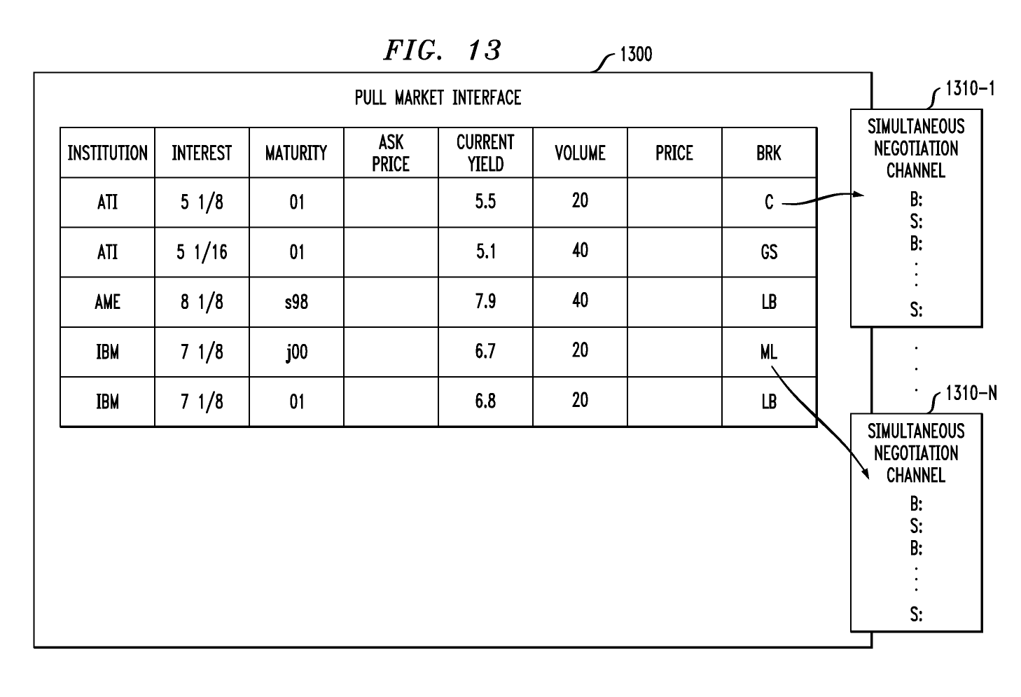

If, however, it is determined during step 1040 that a response is received identifying one or more bids that are in proximity, then for each identified proximate bid, an icon is posted with information about the proximate bid during step 1050 on an appropriate push interface, such as the interface discussed below in conjunction with FIG. 12.

As shown in FIG. 10B, a test is then performed during step 1060 to determine if the user clicks on a response icon within a predefined period. If it is determined during step 1060 that the user does not click on a response icon within the predefined period (or deletes the icon), then the response icon is deleted during step 1080 and program control terminates.

If, however, it is determined during step 1060 that the user does click on a response icon, then a channel is opened during step 1070 for message exchange with the corresponding other party. A test is then performed during step 1075 to determine if the user utilizes the channel within a predefined time period. If it is determined during step 1075 that the user does not use the channel within the predefined period (or deletes the channel), then the response icon and channel are deleted during step 1080 and program control terminates.

If, however, it is determined during step 1075 that the user does use the channel, then negotiation is facilitated between the parties during step 1085. A further test is performed during step 1090 to determine if the user accepts the offer. If it is determined during step 1090 that the user does not accept the offer, then program control returns to step 1085 for further negotiation (optionally, until the channel is deleted by one party or a time-out period is exceeded).

If, however, it is determined during step 1090 that the user does accept the offer, then the bid(s) are removed from the market (bid) database 600 during step 1095, before program control terminates.

FIG. 11 illustrates an exemplary bid submission interface 1100 that assists the user with submitting a bid. As shown in FIG. 11, the bid submission interface 1100 allows a user to specify whether the bid is associated with a buy or a sell, and includes a number of exemplary fields for specifying the price and other parameters associated with each bid. In addition, in accordance with one aspect of the present invention, the bid submission interface 1100 optionally includes a field for specifying one or more authorized market segments to which a bid should be posted.

FIG. 12 illustrates an exemplary push market interface 1200 that provides the user with information about bids in its push market 210. Generally, the push market interface 1200 identifies all bids (Sxx, Byy) submitted by the user, as well as any bids that the centralized financial market management system 300 has identified as being “in proximity.” As shown in FIG. 12, for each proximate bid, an icon is posted adjacent to the original bid with information about the proximate bid. A user can click on the icon of a proximate bid to open a real-time text collaboration session 1210-N. The icons associated with proximate bids can identify, for example, the corresponding market segments and the company name associated with the proximate bid. If the negotiation sessions leads to an accepted offer, the bid can be removed from the push market interface 1200, and the market (bid) database 600, and a clearing transaction can be submitted for the completed transaction.

FIG. 13 illustrates an exemplary pull market interface 1300 that provides the user with information about bids in its pull market 220. As shown in FIG. 13, the pull market interface 1300 identifies bids from other market participants 400 to which the user has been invited. Clicking on a bid in the pull market interface 1300 opens up a collaboration window 1310-N for negotiation, in the same manner as the push market interface 1200.

It is to be understood that the embodiments and variations shown and described herein are merely illustrative of the principles of this invention and that various modifications may be implemented by those skilled in the art without departing from the scope and spirit of the invention.

What is claimed is:

1. A method for submitting a bid for a financial security in a network environment having a plurality of market segments, each of said market segments having at least one market participant, wherein a bid posted to one or more authorized market segments posts said bid only to market participants in said one or more authorized market segments, said method comprising the steps of:
specifying one or more parameters of said bid, including a price;
specifying one or more authorized market segments for said bid; and
sending said bid to a centralized bid server for posting only to market participants in said one or more authorized market segments.

2. The method of claim 1, further comprising the step of receiving a communication channel with another entity associated with a bids that is in proximity to said submitted bid.

3. The method of claim 2, wherein two bids are in proximity if they have parameters that are within a given threshold of each other.

4. A system for submitting a bid for a financial security in a network environment having a plurality of market segments, each of said market segments having at least one market participant, wherein a bid posted to one or more authorized market segments posts said bid only to market participants in said one or more authorized market segments, said system comprising:
a memory that stores computer-readable code; and
a processor operatively coupled to said memory, said processor configured to implement said computer-readable code, said computer-readable code configured to:
specify one or more parameters of said bid, including a price;
specify one or more authorized market segments for said bid; and
send said bid to a centralized bid server for posting only to market participants in said one or more authorized market segments.

5. The system of claim 4, wherein said processor is further configured to receive a communication channel with another entity associated with a bids that is in proximity to said submitted bid.

6. The system of claim 25, wherein two bids are in proximity if they have parameters that are within a given threshold of each other.

7. An article of manufacture for submitting a bid for a financial security in a network environment having a plurality of market segments, each of said market segments having at least one market participant, wherein a bid posted to one or more authorized market segments posts said bid only to market participants in said one or more authorized market segments, comprising:
a computer readable medium having computer readable code means embodied thereon, said computer readable program code means comprising:
a step to specify one or more parameters of said bid, including a price;
a step to specify one or more authorized market segments for said bid; and
a step to send said bid to a centralized bid server for posting only to market participants in said one or more authorized market segments.
